(19) United States
(12) Patent Application Publication
(10) Pub. No.: US 2018/0335716 A1
(43) Pub. Date: Nov. 22, 2018

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Masami OHSHIMA, Sunto Shizuoka (JP)

(21) Appl. No.: 15/926,155

(22) Filed: Mar. 20, 2018

(30) Foreign Application Priority Data
May 17, 2017 (JP) 2017-098471

(51) Int. Cl. B41J 2/385; H05B 33/08

(52) U.S. Cl. CPC G03G 15/04054; H05B 33/0845; G03G 15/0216

(57) ABSTRACT

An image forming apparatus includes a first counter in which a number of light emitting occurrence for each of a plurality of light emitting elements configured to emit light onto an image carrier, is stored, and a processor configured to obtain a difference in the number of light emitting occurrences between a light emitting element having a larger number of light emitting occurrences and a light emitting element having a smaller number of light emitting occurrences, and to cause at least one of the light emitting elements to emit light, based on the difference.

### CROSS-REFERENCE TO RELATED APPLICATION

This application is based upon and claims the benefit of priority from Japanese Patent Application No. 2017-098471, filed May 17, 2017, the entire contents of which are incorporated herein by reference.

### FIELD

Embodiments described herein relate generally to an image forming apparatus and an image forming method.

### BACKGROUND

In recent years, an electrophotography-type image forming apparatus in which a plurality of light emitting diodes (hereinafter, referred to as LEDs) are used as a light source for exposing a photoconductor is known. In such an LED exposure-type image forming apparatus, it is not necessary to provide a polygon mirror. For this reason, in the LED exposure-type image forming apparatus, it is easy to make the apparatus small, and produce the apparatus at a lower cost compared to a light beam scanning-type image forming apparatus in which a polygon mirror is used. The LED has a light intensity degrading property in which intensity of the light emission decreases along with a passage of time. Accordingly, when a usage frequency between each of the LEDs (either a cumulative number of light emitting occurrences, or a cumulative light emission duration) is different, there is a difference in progress of the degree of deterioration in each LED, and as a result, there is a variation in intensity of light emission in each LED. When light intensity of each LED varies, there is a possibility that a defect in image generation, such as a stripe, may occur in a rotation direction of the photoconductor. In order to suppress such a variation in light intensity of each LED, a technology in which a light intensity of the LED is adjusted by storing a use frequency of the LED, and adjusting a current which drives the LED, is known. However, in the related art, there was a case in which a circuit configuration for adjusting light intensity of an LED was needed, and it was not easy to obtain miniaturization and low cost of the apparatus.

### DESCRIPTION OF THE DRAWINGS

FIG. 1 is an external view which illustrates an example of the entire configuration of an image forming apparatus.

FIG. 2 is a diagram which illustrates an example of a configuration of an image forming unit provided in a printing unit.

FIG. 3 is a diagram which illustrates an example of a configuration of an LED light emitting unit.

FIG. 4 is a diagram which illustrates an example of a configuration of a control unit.

FIG. 5 is a diagram which illustrates an example of a functional configuration of a CPU.

FIG. 6 is a flowchart which illustrates an example of an operation of the image forming apparatus.

FIG. 7 is a flowchart which illustrates an example of an operation of the image forming apparatus in image forming processing.

FIG. 8 is a flowchart which illustrates an example of an operation of the image forming apparatus in forcible light emitting processing.

FIG. 9 is a flowchart which illustrates an example of an operation of the image forming apparatus in counting updating processing.

### DETAILED DESCRIPTION

An object of the exemplary embodiment is to provide an image forming apparatus in which it is possible to suppress a variation in intensity of light emitting which occurs in a light source which exposes a photoconductor.

An image forming apparatus according to an embodiment includes a first counter in which a number of light emitting occurrence for each of a plurality of light emitting elements configured to emit light onto an image carrier, is stored, and a processor configured to obtain a difference in the number of light emitting occurrences between a light emitting element having a larger number of light emitting occurrences and a light emitting element having a smaller number of light emitting occurrences, and to cause at least one of the light emitting elements to emit light, based on the difference.

### Regarding Image Forming Apparatus

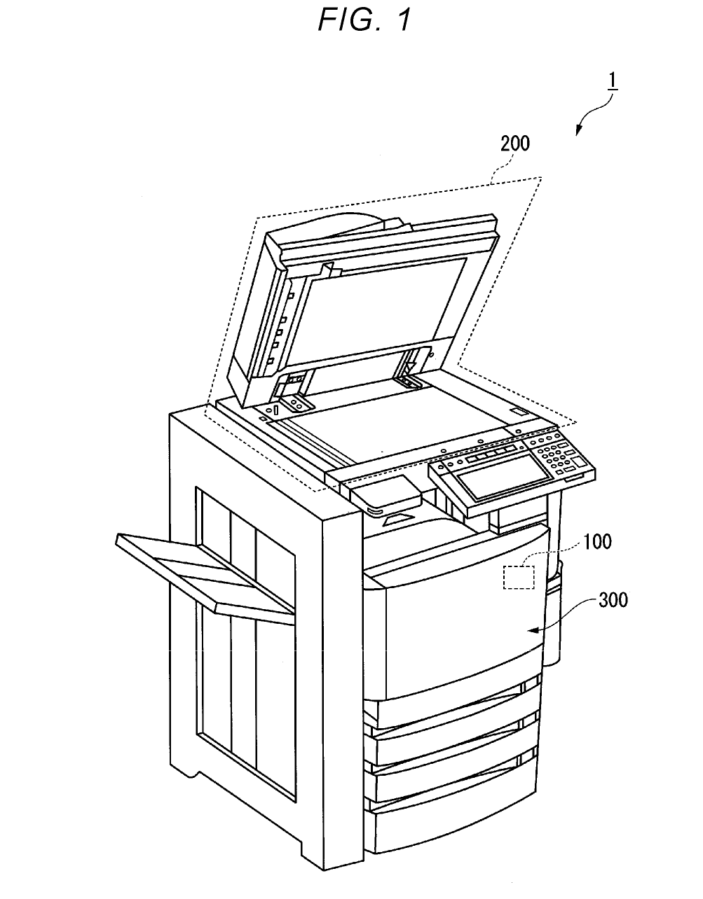

Hereinafter, an image forming apparatus according to an embodiment will be described with reference to drawings. FIG. 1 is an external view which illustrates a configuration example of the entire configuration of an image forming apparatus 1 according to the embodiment. The image forming apparatus 1 is, for example, a multifunction peripheral. The image forming apparatus 1 is provided with a control unit 100, an image reading unit 200, and a printing unit 300.

The image forming apparatus 1 forms an image on a sheet using a developer such as toner, by controlling each functional unit using the control unit 100. The sheet is paper or label paper, for example. The sheet maybe any sheet on which the image forming apparatus 1 can form an image on the surface thereof.

The image reading unit 200 reads an image, which is a reading target, as light and shade, and generates image information from the reading. The image reading unit 200 records the generated image information. The recorded image information may be transmitted to another information processing device through a network. The recorded image information may be formed as an image on a sheet using the printing unit 300.

The printing unit 300 is provided with an image forming unit and a fixing unit. The image forming unit forms an image on a sheet based on the image information generated by the image reading unit 200, or image information received through a communication path. The image forming unit forms an electrostatic latent image on a photoconductive drum based on image information. In addition, the image forming unit forms a visible image by attaching a developer to the electrostatic latent image. As a specific example of the developer, there is toner. The image forming unit transfers the visible image on a sheet. The fixing unit heats and pressurizes the sheet on which the visible image is transferred. In this manner, the visible image is fixed onto the sheet. In addition, the sheet on which an image is formed may be a sheet which is accommodated in a sheet accommodating unit provided in the image forming apparatus 1, or may be a sheet which is manually inserted.

### Regarding Printing Unit

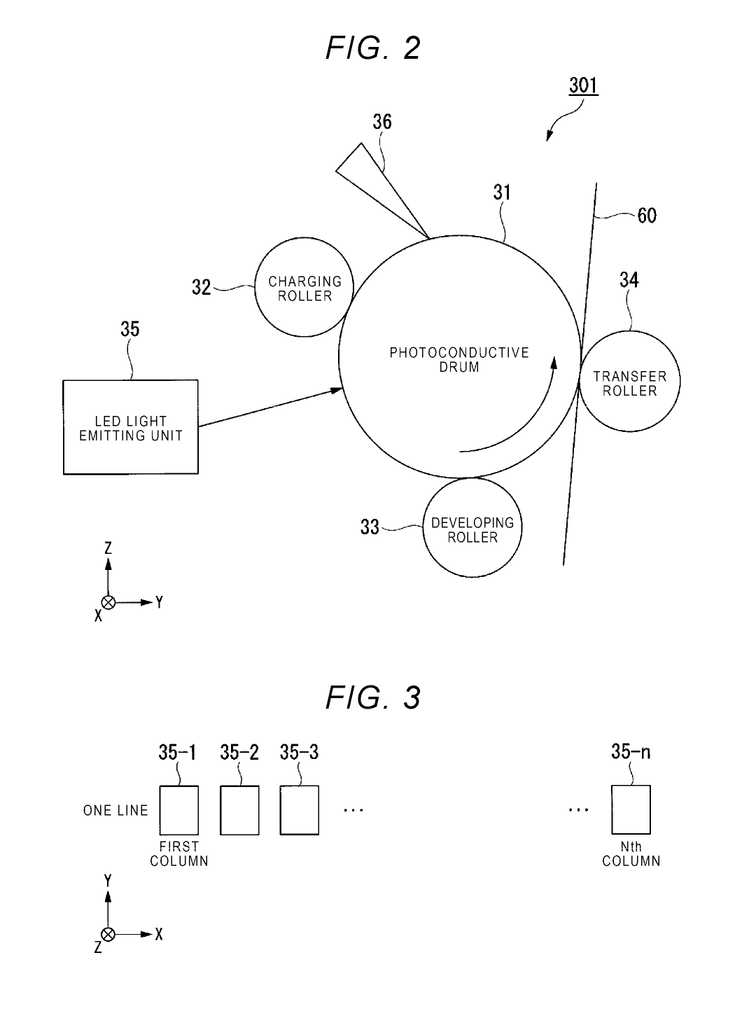

Hereinafter, the printing unit 300 will be described in detail with reference to FIG. 2. FIG. 2 is a diagram which illustrates an example of a configuration of an image forming unit 301 provided in the printing unit 300 in the embodiment. Specifically, FIG. 2 is a sectional view which illustrates a configuration at the periphery of a photoconductive drum 31 provided in the image forming unit 301. In the following descriptions, when describing a configuration at the periphery of the photoconductive drum 31, an XYZ rectangular coordinate system will be used. An X axis denotes a width direction in the configuration at the periphery of the photoconductive drum 31, in the XYZ rectangular coordinate system. A Y axis denotes a depth direction in the configuration at the periphery of the photoconductive drum 31. In addition, a Z axis denotes a height direction in the configuration at the periphery of the photoconductive drum 31. FIG. 2 is a side view in which the configuration at the periphery of the photoconductive drum 31 is viewed from one side in the X axis of a ZY plane (−X direction in the example).

As illustrated in FIG. 2, the image forming unit 301 is provided with, for example, the photoconductive drum 31, a charging roller 32, a developer roller 33, a transfer roller 34, alight emitting diode (hereinafter, referred to as LED), alight emitting unit 35, and a cleaning blade 36. The charging roller 32, the developer roller 33, and the transfer roller 34 are closely disposed in the photoconductive drum 31.

Each unit of the photoconductive drum 31, the charging roller 32, the developer roller 33, and the transfer roller 34 has a length input in the X axis direction corresponding to a width of a sheet. As an example of the embodiment, the photoconductive drum 31 rotates around an axis which passes through a center of the photoconductive drum 31, and is a rotation axis which is parallel to the X axis. The photoconductive drum 31 rotates counterclockwise when viewed from one side in the X axis (−X direction in the example). In addition, each unit of the charging roller 32, the developer roller 33, and the transfer roller 34 rotates in a direction opposite to the photoconductive drum 31 (clockwise direction in the example).

The image forming unit 301 changes the surface of the photoconductive drum 31 using the charging roller 32 when obtaining image information of an image as an image forming target. The LED light emitting unit 35 emits light based on the image information, and performs destaticizing with respect to a portion on the photoconductive drum 31 at which an electrostatic latent image is to be formed, by radiating light (exposure). The developer roller 33 attaches a developer to the electrostatic latent image which is formed on the photoconductive drum 31, to form a visible image. The transfer roller 34 transfers the visible image formed on the photoconductive drum 31 to a sheet 60, when the sheet (hereinafter, referred to as sheet 60) is supplied to the image forming unit 301. The cleaning blade 36 removes unnecessary things such as toner remaining on the surface of the photoconductive drum 31 without being transferred to the sheet 60.

As illustrated in FIG. 2, a case in which the image forming unit 301 of the image forming apparatus 1 according to the embodiment includes one photoconductive drum 31 is described; however, FIG. 2. is not limited to this case. The image forming unit 301 may include a plurality of the photoconductive drums 31, may include configurations at the periphery of the plurality of photoconductive drums 31, and an intermediate belt are provided. The configuration at the periphery of the photoconductive drum 31 is the charging roller 32, the developer roller 33, the transfer roller 34, the cleaning blade 36, and the like, for example. Regarding LED light emitting unit

Hereinafter, a configuration of the LED light emitting unit 35 will be described with reference to FIG. 3. FIG. 3 is a diagram which illustrates an example of a configuration of the LED light emitting unit 35 according to the embodiment. As illustrated in FIG. 3, the printing unit 300 is provided with a plurality of the LED light emitting units 35. Specifically, the printing unit 300 is provided with the number of LED light emitting units 35 corresponding to a width of the photoconductive drum 31, and corresponding to a resolution of an image transferred to the sheet 60. In the example in the embodiment, the printing unit 300 is provided with n LED light emitting units 35. The n is a natural number. In addition, the LED light emitting unit 35 is disposed in one line in a direction parallel to the X axis. In addition, the LED light emitting unit 35 may be disposed in zigzag line in the Y axis direction, along a direction parallel to the X axis. Regarding control unit

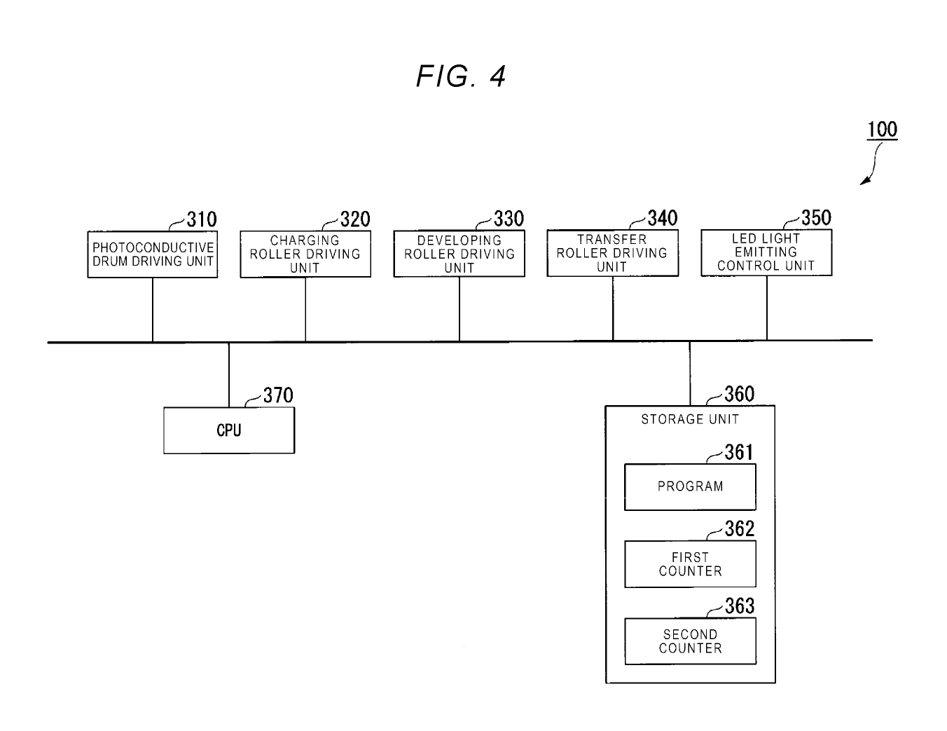

Hereinafter, the control unit 100 will be described in detail with reference to FIG. 4. FIG. 4 is a diagram which illustrates an example of a configuration of the control unit 100 according to the embodiment. The control unit 100 is provided with a photoconductor drum driving unit 310, a charging roller driving unit 320, a developing roller driving unit 330, a transfer roller driving unit 340, a LED light emitting control unit 350, a storage unit 360 and a central processing unit (hereinafter, referred to as CPU) 370.

The photoconductor drum driving unit 310 drives and rotates the photoconductive drum 31, based on a control of the CPU 370. The charging roller driving unit 320 drives and rotates the charging roller 32 based on a control of the CPU 370. The developing roller driving unit 330 drives and rotates the developer roller 33 based on a control of the CPU 370. The transfer roller driving unit 340 drives and rotates the transfer roller 34 based on a control of the CPU 370. The LED light emitting control unit 350 causes the LED light emitting unit 35 to emit light based on a control of the CPU 370. The storage unit 360 is a hard disk drive (HDD), a flash memory, a random access memory (RAM), a read only memory (ROM), or the like. Information of a program 361, or the like, is stored in the storage unit 360. Regarding CPU

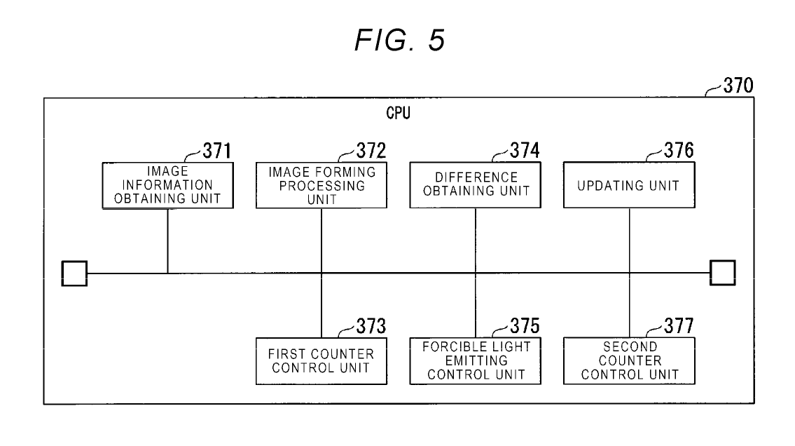

Hereinafter, the CPU 370 will be described in detail with reference to FIG. 5. FIG. 5 is a diagram which illustrates an example of a functional configuration of the CPU 370. The CPU 370 executes the program 361 stored in the storage unit 360 to function as an image information obtaining unit 371, an image forming processing unit 372, a first counter control unit 373, a difference obtaining unit 374, a forcible light emitting control unit 375, an updating unit 376, and a second counter control unit 377.

The image information obtaining unit 371 obtains image information generated by the image reading unit 200, or image information received through a communication path. The image forming processing unit 372 forms an image on the sheet 60 by causing each unit of the printing unit 300 to perform the above described processing based on the image information obtained by the image information obtaining unit 371. In the following descriptions, processing in which an image is formed on the sheet 60 by the image forming processing unit 372, based on the image information will be described as “image forming processing”. The first counter control unit 373 counts the number of occurrences of light emission by each of the LED light emitting units 35, and causes the storage unit 360 to store a count thereof. In the following descriptions, the information specifying the number of occurrences of light emission in each of the LED light emitting units 35 is stored in a first counter 362.

The difference obtaining unit 374 obtains a difference between the number of occurrences of light emission of the LED light emitting unit 35 with the largest number of light emitting occurrences and the number of occurrences of light emission of the LED light emitting unit 35 with the smallest number of light emitting occurrences, based on the first counter 362. Specifically, the difference obtaining unit 374 obtains a difference between the largest number of light emitting occurrences and the smallest number of times of light emitting occurrences that are stored in the first counter 362.

The forcible light emitting control unit 375 forcibly causes the LED light emitting unit 35 to emit light based on a difference in the number of light emitting occurrences which is obtained by the difference obtaining unit 374. Here, the LED light emitting unit 35 produces a difference in light emitting intensity, in association with a difference in the number of light emitting occurrences. Specifically, the intensity of light emitting in the LED light emitting unit 35 with the larger number of light emitting occurrences, is less than the intensity of light emitting in the LED light emitting unit 35 with the smaller number of light emitting occurrences. When there is a difference in the number of light emitting occurrences between the LED light emitting units 35, there is a case in which a quality of an image formed on the sheet 60 deteriorates. The forcible light emitting control unit 375 forcibly causes the LED light emitting unit 35 of which the number of light emitting occurrences is smaller to emit light when the difference in the number of light emitting occurrences is larger than a predetermined number, so that the difference in the number of light emitting occurrences is reduced. The predetermined number is equal to the number of times the LED light emitting unit 35 with the smaller number of light emitting occurrences needs to emit light in order to maintain the quality of an image formed on the sheet 60.

The forcible light emitting control unit 375 generates image information (hereinafter, referred to as forcible light emitting image information) with which the LED light emitting unit 35 with the small number of light emitting occurrences emits light, and supplies the image information to the image forming processing unit 372. The image forming processing unit 372 controls each unit of the printing unit 300 based on the forcible light emitting image information generated by the forcible light emitting control unit 375, and causes the LED light emitting unit 35 to emit light. The forcible light emitting control unit 375 causes the LED light emitting unit 35 to emit light using the forcible light emitting image information, until the number of light emitting occurrences of the LED light emitting unit 35 with the smaller number of light emitting occurrences matches the predetermined number.

The updating unit 376 updates the number of light emitting occurrences in each of the LED light emitting units 35 denoted by the first counter 362 according to the generation of the forcible light emitting image information by the forcible light emitting control unit 375. Specifically, the updating unit 376 subtracts the predetermined number from the number of light emitting occurrences in each of the LED light emitting units 35 stored in the first counter 362. The updating unit 376 causes the value obtained by subtracting the predetermined number to be stored in the first counter 362 as the number of light emitting occurrences of the LED light emitting unit 35.

The second counter control unit 377 counts the number of times the number of light emitting occurrences in each of the LED light emitting unit 35 stored in the first counter 362 reaches the predetermined number of times, and causes the storage unit 360 to store thereof. Specifically, the second counter control unit 377 counts the number of times the number of light emitting occurrences in each of the LED light emitting unit 35 which is stored in the first counter 362, is updated by the updating unit 376. In the following descriptions, information specifying the number of times in which the updating unit 376 updates the number of light emitting occurrences is stored in a second counter 363. Regarding operation of image forming apparatus

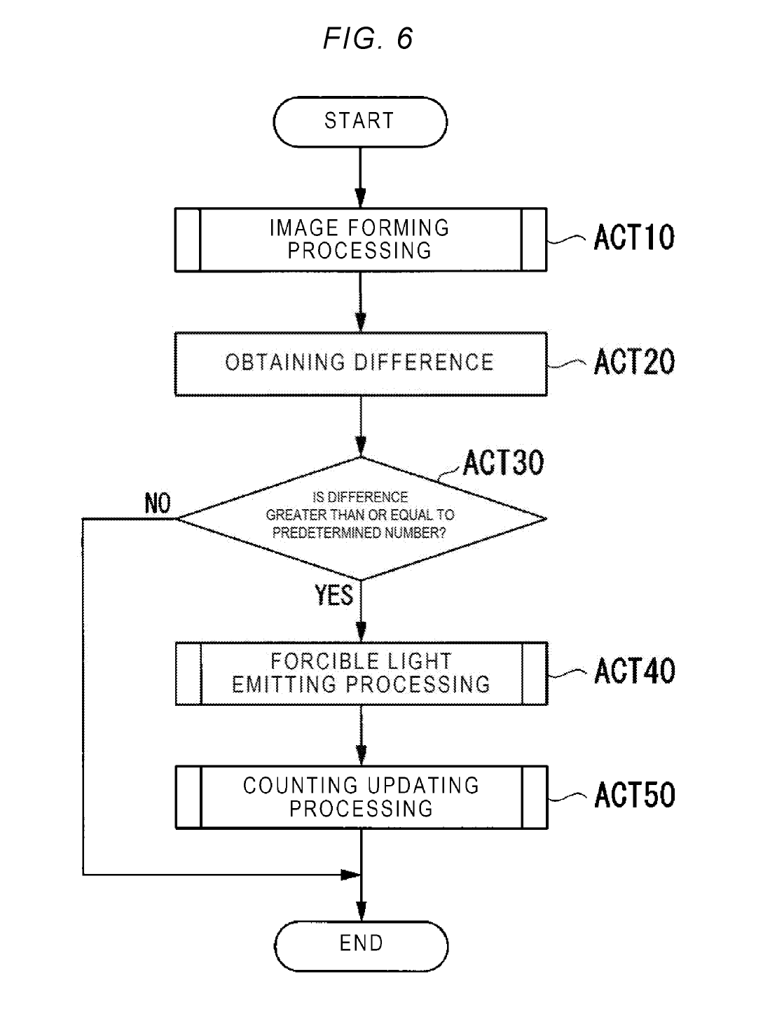

Hereinafter, an operation of the image forming apparatus 1 will be described with reference to FIG. 6. FIG. 6 is a flowchart which illustrates an example of an operation of the image forming apparatus 1 according to the embodiment. First, the image forming apparatus 1 performs image forming processing (ACT 10).

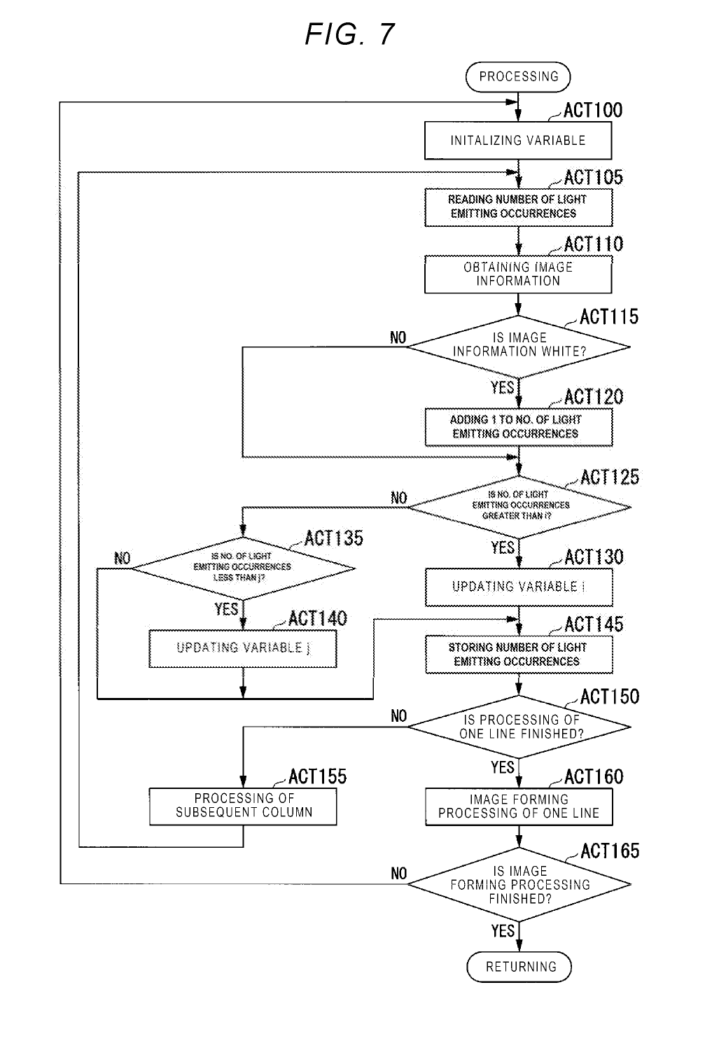

Hereinafter, ACT 10 will be described in detail with reference to FIG. 7. FIG. 7 is a flowchart which illustrates an example of an operation of the image forming apparatus 1 in the image forming processing according to the embodiment. The difference obtaining unit 374 initializes a variable which is used in the processing (ACT 100). In one example according to the embodiment, the difference obtaining unit 374 initializes a variable i, a variable j, and a variable k in ACT 100. The variable i is a variable that tracks the largest number of light emitting occurrences in the number of light emitting occurrences stored in the first counter 362. The variable j is a variable that tracks the smallest number of light emitting occurrences in the number of light emitting occurrences stored in the first counter 362. The variable k is a variable that corresponds to a particular column of the LED light emitting unit 35. The difference obtaining unit 374 initializes the variable i to a small value (for example, zero) in ACT 100. The difference obtaining unit 374 initializes the variable j to a large value (for example, the predetermined number) in ACT 100. In addition, the difference obtaining unit 374 initializes the variable k as the value of a column of the LED light emitting unit 35 which is at an end portion in ACT 100.

Subsequently, the difference obtaining unit 374 reads the number of light emitting occurrences of the LED light emitting unit 35 which is in a column of the variable k from the storage unit 360 (ACT 105). As described above, a value of the variable k is “1” in ACT 100. Accordingly, the difference obtaining unit 374 starts processing with respect to the number of light emitting occurrences of the LED light emitting unit 35 disposed in the first column (LED light emitting unit 35-1 illustrated in FIG. 3). In addition, the difference obtaining unit 374 performs processing in order from the LED light emitting unit 35-1 to an LED light emitting unit 35-n processing. In the embodiment, the case in which the variable k is “1” is described; however it is not limited to this. The difference obtaining unit 374 may start processing from any of the LED light emitting units 35, as long as all of the LED light emitting units 35 provided in the printing unit 300 are processed.

Subsequently, the image information obtaining unit 371 obtains image information generated by the image reading unit 200, or image information received through a communication path (ACT 110). Subsequently, the difference obtaining unit 374 determines whether or not a portion at which the LED light emitting unit 35 disposed in the column of the variable k forms an electrostatic latent image that is a white color, in the obtained image information (ACT 115). In addition, when the LED light emitting unit 35 disposed in the column of the variable k emits light, and the portion at which the electrostatic latent image is formed is not a white color (No in ACT 115), the first counter control unit 373 proceeds to ACT 125 without incrementing the number of light emitting occurrences. When the portion at which the LED light emitting unit 35 disposed in the column of the variable k forms an electrostatic latent image that is a white color (Yes in ACT 115), the first counter control unit 373 adds 1 to the number of light emitting occurrences of the LED light emitting unit 35 which is disposed in the column of the variable k, in the first counter 362 (ACT 120).

Subsequently, the difference obtaining unit 374 determines whether or not a value of the number of light emitting occurrences of the LED light emitting unit 35 disposed in the column of the variable k is larger than a value of the variable i (ACT 125). When the value of the number of light emitting occurrences of the LED light emitting unit 35 disposed in the column of the variable k is larger than the value of the variable i (Yes in ACT 125), the difference obtaining unit 374 updates the value of the variable i to a value of the number of light emitting occurrences (ACT 130). In addition, when the value of the number of light emitting occurrences of the LED light emitting unit 35 disposed in the column of the variable k is smaller than the value of the variable i (No in ACT 125), the difference obtaining unit 374 determines whether or not a value of the number of light emitting occurrences is smaller than a value of the variable j (ACT 135). When the value of the number of light emitting occurrences of the LED light emitting unit 35 disposed in the column of the variable k is smaller than the value of the variable j (Yes in ACT 135), the difference obtaining unit 374 updates the value of the variable j to the value of the number of light emitting occurrences (ACT 140). When the value of the number of light emitting occurrences of the LED light emitting unit 35 disposed in the column of the variable k is the value of the variable j or more (No in ACT 135), the difference obtaining unit 374 proceeds the processing to ACT 145 without updating the value of the variable j.

Subsequently, the first counter control unit 373 causes the number of light emitting occurrences of the LED light emitting unit 35 disposed in the column of the variable k to be stored in the first counter 362 (ACT 145). Subsequently, the difference obtaining unit 374 determines whether or not processing of one line from ACT 105 to ACT 145 is finished (ACT 150). Specifically, the difference obtaining unit 374 determines whether or not the variable k is smaller than n, that is, whether or not the above described processing is processing with respect to the LED light emitting unit 35-n in the nth column. When the processing of one line from ACT 105 to ACT 145 is not finished (No in ACT 150), the difference obtaining unit 374 performs processing with respect to the subsequent column (ACT 155). Specifically, the difference obtaining unit 374 adds 1 to the variable k, and proceeds the processing to ACT 105. When the processing of one line from ACT 105 to ACT 145 is finished (Yes in ACT 150), the image forming processing unit 372 performs image forming processing of one line (ACT 160).

Subsequently, the image forming processing unit 372 determines whether or not image forming processing of an image included in the image information is finished (ACT 165). When the image forming processing of the image included in the image information is finished (Yes in ACT 165), the control unit 100 proceeds the processing to ACT 20. When the image forming processing of the image included in the image information is not finished (No in ACT 165), the control unit 100 performs image forming processing of the subsequent line using the processing from ACT 100 to ACT 160.

Returning to FIG. 6, the difference obtaining unit 374 obtains a difference between the largest light emitting occurrences and the smallest light emitting occurrences in the number of light emitting occurrences stored in the first counter 362 (ACT 20). Here, when the processing in ACT 10 is performed, the variable i denotes a value of the largest number of light emitting occurrences after performing the image forming processing of the image included in the image information. In addition, when the processing in ACT 10 is performed, the variable j denotes a value of the smallest number of light emitting occurrences after performing the image forming processing of the image including in the image information. The difference obtaining unit 374 obtains a difference between the largest number of light emitting occurrences and the smallest number of light emitting occurrences by subtracting the variable j from the variable i. The difference obtaining unit 374 determines whether or not the obtained difference value is the predetermined number of light emitting occurrences or more (ACT 30). When the obtained difference value is the predetermined number or more (Yes in ACT 30), the control unit 100 performs forcible light emitting processing in which the LED light emitting unit 35 with the small number of light emitting occurrences is forcibly caused to perform light emission (ACT 40). When the obtained difference value is smaller than a value denoted by the predetermined number (No in ACT 30), the control unit 100 finishes the processing.

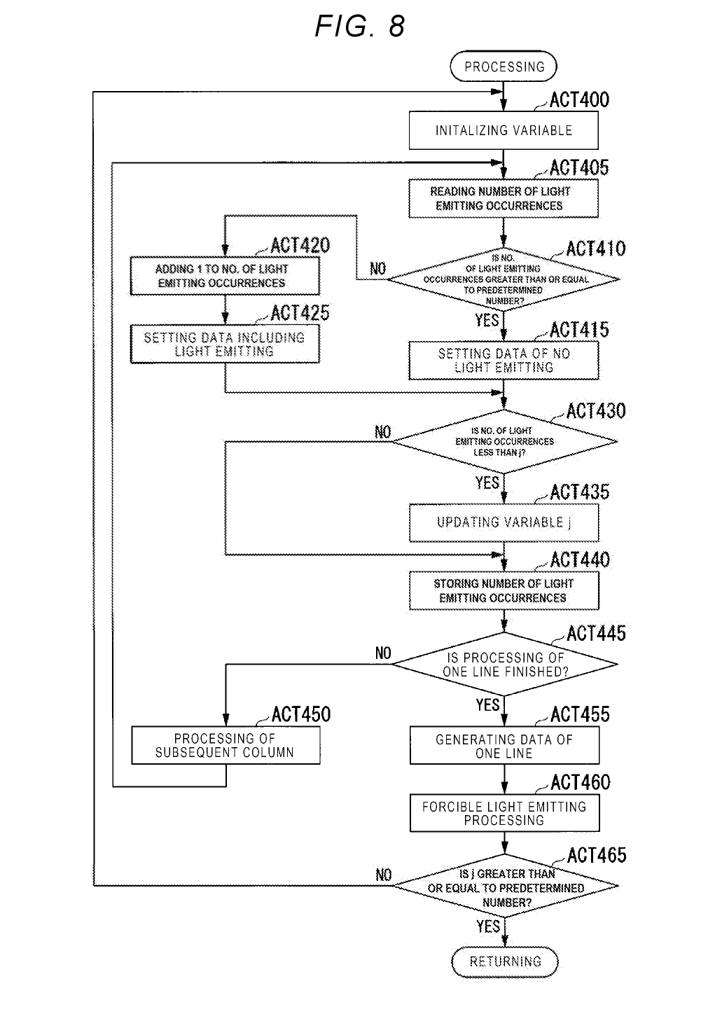

Hereinafter, ACT 40 will be described in detail with reference to FIG. 8. FIG. 8 is a flowchart which illustrates an example of an operation of the image forming apparatus 1 in the forcible light emitting processing according to the embodiment.

The forcible light emitting control unit 375 initializes the variable j and the variable k (ACT 400). The forcible light emitting control unit 375 initializes the variable j as a large value (for example, predetermined number of occurrences) in ACT 400. In addition, the forcible light emitting control unit 375 initializes the variable k as a value of the column of the LED light emitting unit 35 at an end portion (for example, 1) in ACT 400.

Subsequently, the forcible light emitting control unit 375 reads the number of light emitting occurrences of the LED light emitting unit 35 disposed in the column of the variable k from the storage unit 360 (ACT 405). The forcible light emitting control unit 375 determines whether or not the number of light emitting occurrences of the LED light emitting unit 35 disposed in the column of the variable k is the predetermined number of occurrences or more (ACT 410). When the number of light emitting occurrences of the LED light emitting unit 35 disposed in the column of the variable k is the predetermined number of occurrences or more (Yes in ACT 410), the forcible light emitting control unit 375 sets data which does not cause light emitting by the LED light emitting unit 35 disposed in the column of the variable k (ACT 415). When the number of light emitting occurrences of the LED light emitting unit 35 disposed in the column of the variable k is less than the predetermined number of occurrences (No in ACT 410), the first counter control unit 373 adds 1 to the number of light emitting occurrences of the LED light emitting unit 35 disposed in the column of the variable k, in the first counter 362 (ACT 420). Subsequently, the forcible light emitting control unit 375 sets data which causes light emitting by the LED light emitting unit 35 disposed in the column of the variable k (ACT 425).

Subsequently, the forcible light emitting control unit 375 determines whether or not the number of light emitting occurrences of the LED light emitting unit 35 disposed in the column of the variable k is smaller than the variable j (ACT 430). When the number of light emitting occurrences of the LED light emitting unit 35 disposed in the column of the variable k is smaller than a value of the variable j (Yes in ACT 430), the forcible light emitting control unit 375 updates the value of the variable j to the number of light emitting occurrences (ACT 435). When the number of light emitting occurrences of the LED light emitting unit 35 disposed in the column of the variable k is a value of the variable j or more (No in 430), the forcible light emitting control unit 375 proceeds the processing to ACT 440 without updating the variable j.

Subsequently, the first counter control unit 373 causes the number of light emitting occurrences of the LED light emitting unit 35 disposed in the column of the variable k to be stored in the first counter 362 (ACT 440). Subsequently, the forcible light emitting control unit 375 determines whether or not the processing of one line from ACT 405 to ACT 440 is finished (ACT 445). Specifically, the forcible light emitting control unit 375 determines whether or not the variable k is smaller than n, that is, whether or not the above described processing is processing with respect to the LED light emitting unit 35-n in the nth column. When the processing from ACT 405 to ACT 440 of one line is not finished (No in ACT 445), the forcible light emitting control unit 375 performs processing with respect to the subsequent column (ACT 450). Specifically, the forcible light emitting control unit 375 proceeds the processing to ACT 405 by adding 1 to the variable k. When the processing from ACT 405 to ACT 440 of one line is finished (Yes in ACT 445), the forcible light emitting control unit 375 generates forcible light emitting image information of one line based on data which is set in each of the LED light emitting units 35 (ACT 455). The image forming processing unit 372 forcibly causes the LED light emitting unit 35 to emit light based on the forcible light emitting image information generated by the forcible light emitting control unit 375 (ACT 460). The image forming processing unit 372 forcibly causes the LED light emitting unit 35 to emit light between obtaining of the forcible light emitting image information and the subsequent image forming processing, for example. In addition, the image forming processing unit 372 may not perform processing with respect to each unit of the printing unit 300 other than the LED light emitting unit 35 based on the forcible light emitting image information.

Subsequently, the forcible light emitting control unit 375 determines whether or not a value denoted by the variable j is a value of the predetermined number of occurrences or more (ACT 465). When the value denoted by the variable j is smaller than the value of the predetermined number (No in ACT 465), the control unit 100 repeats processing from ACT 400 to ACT 460. In other words, the control unit 100 repeats the processing ACT 400 to ACT 460 until the number of light emitting occurrences of the LED light emitting unit 35 with the smallest number of light emitting occurrences becomes the predetermined number or more. In addition, when the value denoted by the variable j is the predetermined number of occurrences or more (Yes in ACT 465), the control unit 100 proceeds the processing to ACT 50.

Returning to FIG. 6, the control unit 100 performs updating of the first counter 362 and the second counter 363, according to the forcible light emitting processing in ACT 40 (ACT 50).

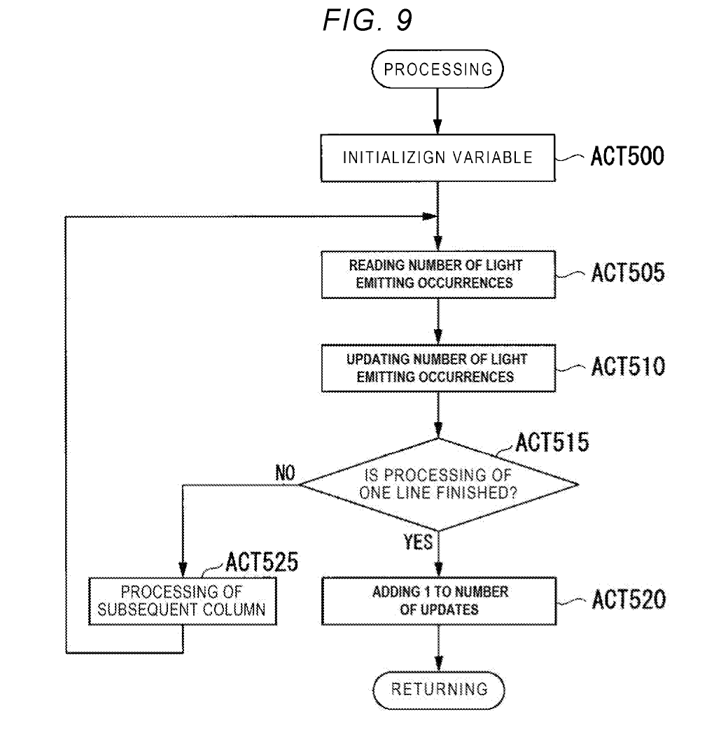

Hereinafter, ACT 50 will be described in detail with reference to FIG. 9. FIG. 9 is a flowchart which illustrates an example of an operation of the image forming apparatus 1 in count updating processing according to the embodiment. The updating unit 376 initializes the variable k (ACT 500). Specifically, the updating unit 376 initializes the variable k as a value of the column of the LED light emitting unit 35 disposed at an end portion (for example, 1) in ACT 500.

Subsequently, the updating unit 376 reads the number of light emitting occurrences of the LED light emitting unit 35 disposed in the column of the variable k from the storage unit 360 (ACT 505). The updating unit 376 updates the number of light emitting occurrences which is read, and stores the updated number in the first counter 362 (ACT 510). Specifically, the updating unit 376 subtracts the predetermined number of occurrences from the number of light emitting occurrences which is read, and stores thereof in the first counter 362.

Subsequently, the updating unit 376 determines whether or not processing of ACT 505 and ACT 510 of one line is finished (ACT 515). Specifically, the updating unit 376 determines whether or not the variable k is smaller than n that is, whether or not the above described processing is processing with respect to the LED light emitting unit 35-n in the nth column. When the processing of ACT 505 and ACT 510 of one line is not finished (No in ACT 515), the updating unit 376 performs processing with respect to the subsequent column (ACT 525). Specifically, the updating unit 376 proceeds the processing to ACT 505 by adding 1 to the variable k. When the processing of ACT 505 and ACT 510 of one line is finished (Yes in ACT 515), the second counter control unit 377 adds 1 to the number stored in the second counter 363, and stores the updated number in the second counter 363 (ACT 520).

As described above, the image forming apparatus 1 according to the embodiment obtains a difference in the number of light emitting occurrences between the LED light emitting unit 35 with the largest number of light emitting occurrences and the LED light emitting unit 35 with the smallest number of light emitting occurrences. In addition, the image forming apparatus 1 according to the embodiment forcibly causes the LED light emitting unit 35 to emit light based on the obtained difference. In this manner, the image forming apparatus 1 according to the embodiment can suppress a difference in number of light emitting occurrences between the LED light emitting units 35. That is, the image forming apparatus 1 according to the embodiment can suppress a variation in intensity of light emitting which occurs in the LED light emitting unit 35 in a simple method, without using a circuit configuration which adjusts intensity of the LED. Accordingly, in the image forming apparatus 1 according to the embodiment, it is possible to suppress a deterioration in quality of an image formed on the sheet 60.

In the image forming apparatus 1 according to the embodiment, the second counter control unit 377 stores the number of times the number of light emitting occurrences of the LED light emitting unit 35 stored in the first counter 362 reaches the predetermined number of times. Accordingly, the image forming apparatus 1 according to the embodiment can store the number of light emitting occurrences in each of the LED light emitting units 35 in a lump, as much as the predetermined number, using the second counter 363. In this manner, the image forming apparatus 1 according to the embodiment can reduce storage capacity compared to a case in which the number of light emitting occurrences of the LED light emitting unit 35 is continuously stored in the first counter 362.

When the number of light emitting occurrences of the LED light emitting unit 35 reaches the predetermined number, the updating unit 376 in the image forming apparatus 1 according to the embodiment subtracts the predetermined number from the number of light emitting times, and updates the number of light emitting occurrences stored in the first counter 362. Accordingly, the image forming apparatus 1 according to the embodiment can reduce the storage capacity which is used when the first counter 362 stores the number of light emitting occurrences.

In addition, in the image forming apparatus 1 according to the embodiment, the second counter 363 stores the number of times the number of light emitting occurrences of the LED light emitting unit 35 reaches the predetermined number of times, while subtracting the predetermined number of times from the number of light emitting occurrences stored in the first counter 362. In this manner, the image forming apparatus 1 according to the embodiment can track the number of light emitting occurrences of the LED light emitting unit 35 with high accuracy.

In the above descriptions, the case in which the difference obtaining unit 374, the forcible light emitting control unit 375, and the updating unit 376 perform various processing based on the predetermined number of occurrences; however, the above case is not limited to this. The various processing may be performed based on a predetermined light emitting time, and a light emitting time of the LED light emitting unit 35, for example. The light emitting time of the LED light emitting unit 35 is, for example, a value obtained by multiplying a light emission duration per one LED light emitting unit 35 by the number of light emitting occurrences of the LED light emitting unit 35. In this case, the difference obtaining unit 374, the forcible light emitting control unit 375, and the updating unit 376 have a function of calculating a light emitting duration, based on the number of light emitting occurrences of the LED light emitting unit 35.

The difference obtaining unit 374 obtains a difference in light emitting duration based on the largest light emitting duration and the smallest light emitting duration, in the number of light emitting durations stored in the first counter 362, according to the above described configuration, for example.

The forcible light emitting control unit 375 sets data which does not cause light emitting by the LED light emitting unit 35 of which the calculated number of light emitting duration is longer than the predetermined light emitting duration. In addition, the forcible light emitting control unit 375 sets data which cause light emitting by the LED light emitting unit 35 of which the calculated number of light emitting duration is shorter than the predetermined light emitting duration.

The updating unit 376 stores a value obtained by subtracting the number of light emitting duration corresponding to the predetermined light emitting duration from the number of light emitting durations stored in the first counter 362 in the first counter 362. The number of light emitting durations corresponding to the predetermined light emitting time is a value obtained by dividing the predetermined number of light emitting duration by a light emitting time per one light emitting of the LED light emitting unit 35.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a first counter in which a number of light emitting occurrence for each of a plurality of light emitting elements configured to emit light onto an image carrier, is stored; and
a processor configured to obtain a difference in the number of light emitting occurrences between a light emitting element having a larger number of light emitting occurrences and alight emitting element having a smaller number of light emitting occurrences, and cause at least one of the light emitting elements to emit light, based on the difference.

2. The apparatus according to claim 1, further comprising:
a second counter configured to store the number of times all of the number of light emitting occurrences stored in the first counter reaches a predetermined number of occurrences.

3. The apparatus according to claim 2, wherein the processor is further configured to subtract a predetermined number of occurrences from each of the number of light emitting occurrences stored in the first counter when all of the number of light emitting occurrences stored in the first counter reaches the predetermined value, and update the number of light emitting occurrences stored in the first counter.

4. The apparatus according to claim 3,
wherein the light emitting control unit causes a light emitting element for which the number of light emitting occurrences stored in the first counter is smaller than the predetermined value to emit light.

5. The apparatus according to claim 1, wherein the image carrier is a photoconductive drum.

6. The apparatus of according to claim 1, wherein the plurality of light emitting elements are disposed in an array.

7. The apparatus according to claim 1, wherein the light emitting element having the larger number of light emitting occurrences is the light emitting element having the largest number of light emitting occurrences amongst the plurality of light emitting elements.

8. The apparatus according to claim 1, wherein the light emitting element having the smaller number of light emitting occurrences is the light emitting element having the smallest number of light emitting occurrences amongst the plurality of light emitting elements.

9. The apparatus according to claim 1, wherein the at least one of the light emitting elements caused to emit light includes a light emitting element having a smallest number of light emitting occurrences amongst the plurality of light emitting elements.

10. An image forming method comprising:
storing a number of light emitting occurrence for each of a plurality of light emitting elements in a first counter;
obtaining a difference in the number of lighting occurrences between a light emitting element having a larger number of light emitting occurrences and a light emitting element having a smaller number of light emitting occurrences; and
causing at least one of the light emitting elements to emit light based on the difference.

11. The image forming method according to claim 10, wherein the at least one of the light emitting elements caused to emit light includes the light emitting element having the smallest number of light emitting occurrences amongst the plurality of light emitting elements.

12. The image forming method according to claim 11, wherein the light emitting element having the smaller number of light emitting occurrences is the light emitting element having the smallest number of light emitting occurrences amongst the plurality of light emitting elements.

13. The image forming method according to claim 10, wherein the light emitting element having the larger number of light emitting occurrences is the light emitting element having the largest number of light emitting occurrences amongst the plurality of light emitting elements.

14. The image forming method according to claim 10, wherein the plurality of light emitting elements directs light onto an image carrier.

15. The image forming method according to claim 14, wherein the image carrier is a photoconductive drum.

16. The image forming method according to claim 15, wherein the light emitting elements of the plurality of light emitting elements are disposed in an array.

17. The image forming method according to claim 10, further comprising:
storing a number of occurrences in which the number of light emitting occurrences stored in the first counter reaches a predetermined value.

18. The image forming method according to claim 17, further comprising:
subtracting a predetermined number of occurrences from all of the number of light emitting occurrences when the number of light emitting occurrences stored in the first counter reaches the predetermined value, and updating the number of light emitting occurrences stored in the first counter.

19. An image forming apparatus comprising:
a first counter in which a number of light emitting durations for each of a plurality of light emitting elements configured to emit light onto an image carrier, is stored; and
a processor configured to obtain a difference in the light emitting duration between a light emitting element having a larger light emitting duration and a light emitting element having a smaller light emitting duration, and cause at least one of the light emitting elements to emit light, based on the difference.

20. The image forming method according to claim 19, wherein the at least one of the light emitting elements caused to emit light includes the light emitting element having the smallest light emitting duration amongst the plurality of light emitting elements.
